(19) United States
(12) Patent Application Publication
(10) Pub. No.: US 2016/0201206 A1
(43) Pub. Date: Jul. 14, 2016

(54) Conducting Carbon Cloth Electrode for Hydrogen Generation and Dye Sensitized Solar Cells

(71) Applicant: Council of Scientic & Industrial Research, New Delhi (IN)

(72) Inventors: Mandakini BISWAL, Pune, Maharashtra (IN); Sarika Aditya KELKAR, Pune, Maharashtra (IN); Mukta Chandrakant TATHAVEDKAR, Pune, Maharashtra (IN); Shruti Anil AGARKAR, Pune, Maharashtra (IN); Satishchandra Balkrishna OGALA, Pune, Maharashtra (IN)

(73) Assignee: Council of Scientific & Industrial Research, New Delhi (IN)

(21) Appl. No.: 14/905,668

(22) PCT Filed: Jul. 23, 2014
(86) PCT No.: PCT/IN2014/000485

§ 371 Date: Jan. 15, 2016

(30) Foreign Application Priority Data
Jul. 23, 2013 (IN) 2186/DEL/2013

(51) Int. Cl. C25B 11/12; C25B 1/04; C25B 11/03; H01G 9/20

(52) U.S. Cl. CPC C25B 11/12; H01G 9/2022; C25B 1/04; C25B 11/03

(57) ABSTRACT

Disclosed herein is functional conducting carbon cloth with permeability and turbostratic disorder, and process for preparation of the same. Further it describes use of said carbon cloth as anode in alkaline water electrolysis for generation of hydrogen at sub-threshold potential (<1.23V) and generation of carbon quantum dots (CQDs) at super-threshold potential (>1.23V). The invention also relates to the efficient use of the said carbon cloth as counter electrode in Dye Sensitized Solar Cells (DSSCs).

The following specification particularly describes the invention and the manner in which it is to be performed.

### FIELD OF THE INVENTION

The present invention provides a functional conducting carbon cloth with turbostratic disorder and process for preparation of the same. Particularly, present invention provides simultaneous process for generation of hydrogen at sub-threshold potential i.e. <1.23V and generation of carbon quantum dots (CQDs) at super-threshold potential >1.23V in alkaline water electrolysis employing functional conducting carbon cloth as anode having turbostratic structure. More particularly, the invention also relates to the efficient use of carbon cloth, as an electronically and catalytically functional counter electrode for Dye Sensitized Solar Cells (DSSC). Moreover, the conducting cloth also provides a permeable and flexible counter electrode that facilitates the fabrication process of DSSCs.

### BACKGROUND AND PRIOR ART OF THE INVENTION

Carbon based materials have remained at the forefront of chemistry and materials science research due to their attractive chemical, electronic and catalytic properties. The ubiquity and existence of carbon in different structural and functional forms (in bulk as well as nano) make it even richer in terms of the variety properties it supports. Indeed, the electronic, thermal and optoelectronic behaviour of carbon nanotubes, graphene and graphene quantum dots have made this evident more than ever in recent times. In the context of this current energy crisis and the intense research towards efficient, cost effective and clean energy generation and storage, such carbon based systems and their composites with other materials promise very interesting options. Studies of such low dimensional low Z forms are also enriching from the standpoint of fundamental science.

The potential of hydrogen gas as a fuel is unarguable; the energy density is one of the highest (120 J/gm) with water as the by-product of the combustion. Moreover, Hydrogen can be produced from several different sources such as water, biomass, natural gas or coal. Currently the most commonly used and fairly efficient method of hydrogen production is coal gasification and methane reforming reaction, both having energy intensive with bad environmental impacts. Hydrogen generation from biomass is a sustainable method but is still far from being efficient. Water electrolysis is one of the earliest known methods of producing highly pure gases of hydrogen and oxygen. The discovery of electrolytic water splitting was first observed in acidic water, however due to corrosion related concerns alkaline water electrolysis has become more common in water electrolysis technology. Other related methods developed in recent times are proton exchange membrane water electrolysis and steam electrolysis. In alkaline electrolysis, the half cell reactions are as follows:

At cathode 2H₂O+2e⁻→2OH⁻+H₂⇑

At anode 2OH⁻→H₂O+2e⁻+½O₂⇑

Net reaction 2H₂O→H₂+½O₂+H₂O

As per the above reactions, hydrogen is evolved at the cathode and OH⁻ ions get oxidized with the evolution of oxygen at anode. Therefore the kinetics of this electrochemical reaction is highly dependent upon the type and configuration of anode and cathode. The rate of oxidation of OH⁻ ions to oxygen molecule at the anode surface is usually very poor and is the limiting factor in alkaline electrolysis process. The theoretical minimum potential required for this reaction to occur is 1.23V with respect to normal hydrogen electrode (NHE). In real electrolysis process due of several resistive factors at the interfaces of the electrode/electrolyte and electrode/conducting substrate an overpotential of 0.3 to 0.8V is required. The overall efficiency of the electrolytic water splitting reaction depends upon the minimization of this overpotential, which can be possible by selecting the electrode material with favorable microstructure, pore structure and electrocatalytic property (electrode (to improve the reaction kinetics of the OH— oxidation to oxygen molecule), by selecting the appropriate electrolyte and by appropriately designing the electrolytic cell (distance between electrodes, sizes of electrodes etc). Amongst these the selection of electrode is the most crucial parameter. Platinum is known as the most efficient electrode material for water reduction, followed by stainless steel, which is more commonly used in the industry. Recently graphite and carbon nanotube based electrodes have been studied as potentially low cost and efficient anode materials. Dubey et al. in Hydrogen generation by water electrolysis using carbon nanotube anode, International journal of hydrogen energy, 2010, 35, 3945-3950 showed that the defects on the surface of multiwall carbon nanotube pellet play a key role in enhancing the current density of the electrode. However, since the amount of hydrogen being produced is directly correlated to the current (or charge) being passed through the electrolytic cell, it really comes down to the threshold voltage (and overpotential) when one wants to operate the cell at lower wattage (or at higher efficiency).

In this context in 1979 Farooque et al. in Hydrogen production from coal, water and electrons, Nature, 1979, 279, 301-303 had proposed a carbon assisted water electrolysis process in which coal slurry was used as the sacrificial agent in acidic water where CO₂ (instead of O₂) and H₂ evolved during the electrolysis. Since carbon oxidation to CO₂ thermodynamically requires less energy (threshold at 0.8V Vs RHE), this mechanism provided overall reduction in the overpotential for water splitting. Seehra et al. further studied and optimized this process but the yield remained lower in the operating voltages below 1.23 V.

Further the use of carbon as an electrode material is reported in few literature such as F. Cœuret et al. in Journal of Applied Electrochemistry October 2002, 32, (10), pp 1175-1182) discloses carbon fibre cloth electrodes, employed in the fabrication of composite materials. Raoudha Haddad et al. in Electroanalysis Volume 25. Issue 1, pages 59-67. January 2013 discloses Carbon nanotubes (CNTs) grown on carbon cloth which substantially increased the surface area of the electrodes and Z. D. Wei et al. in Electrochimica Acta 52, (9), 2007, Pages 3323-3329 discloses water electrolysis on the carbon cloth electrode (CC) enhanced by a cationic surfactant, namely, hexadecyltrimethylammonium bromide (HTMAB). However none of the literature describes the dual nature of conducting carbon cloth in alkaline electrolysis against the applied potential.

In the light of the above there remains a need in the art to provides a functional conducting carbon cloth useful as anode in alkaline electrolysis process with the evolution of hydrogen at much lower potential (0.2V) than the required practical potential of 1.7V (1.23 V theoretically). Selection of electrode materials which provide lower activation energies for the reaction taking place at both the electrodes is crucial for the electrolysis process. Hence electrode material with high exchange current density (current density at zero overpotential) is required to be used as electrode material.

DSSCs have attracted a lot of attention recently as an affordable alternative to Silicon based solar cells. Being a clean energy source and with respectable energy conversion efficiency efforts are now initiated towards the commercialization of DSSCs by companies like G24i, Konark etc. A typical DSSC comprises of a photoanode and a counter electrode (cathode) separated by liquid redox electrolyte (namely I⁻/I₃⁻). Photoanode is a dye loaded nanostructured film of wide bandgap semiconductor material on a transparent conducting oxide (TCO) and the counter electrode-cathode consist of a thin layer of Platinum coated TCO which acts as a catalyst for the reduction of I₃⁻. Counter electrodes are keyplayers in determining the efficiency of energy conversion and thus a lot of efforts are put into the designing of such electrodes. Pt (supported on Indium Tin Oxide (ITO) or Fluorine Doped Tin Oxide (FTO)) has thus far proved to be the best in this regard, but clearly there is a need to replace this expensive and rare material. To be a viable counter electrode the material must show good catalytic activity towards reduction of I₃⁻ present in the electrolyte, be stable, and also preferably earth abundant. Carbon has been found to be a suitable candidate in this respect and has the advantages of low cost in addition to its good catalytic activity, and thermal/chemical stability. Carbon in its various forms like activated carbon, graphene, fullerene derived, CNTs etc. has been used as a counter electrode material in DSSC. Activated carbon was used by Imoto et al. in Solar Energy Materials and Solar Cells 79 (2003) 459, as DSSC counter electrode, wherein it was shown that by increasing the surface roughness of carbon the efficiency of DSSC can be enhanced. There are several reports on the effects of different particle sizes of carbon on the efficiency of DSSC. It has also been shown that nanocarbon gives better efficiency as compared to micro carbon. However, almost all of these carbon forms have to be deposited on some substrate so as to be used as a counter electrode. This has to be followed by drilling of a hole in counter electrode for electrolyte injection and finally sealing of the counter and working electrodes with a low melting polymer. These steps make the cell fabrication process time consuming and tedious. Thus there is a need to make this whole fabrication process easy, process friendly and cost effective.

### OBJECTS OF THE INVENTION

Main objective of the present invention is to provide a functional conducting carbon cloth with turbostratic disorder and process for preparation of the same.

Another objective of the present invention is to provide a low cost carbon anode material for alkaline electrolysis process for the generation of hydrogen gas with high efficiency and exchange current density.

Yet another objective of the present invention is to provide cost effective generation of carbon quantum dots by alkaline electrolysis process.

Yet another objective of the invention is to provide a carbon-based conducting and catalytic counter electrode for DSSC's.

Yet another objective of the invention is to provide a simple, convenient and cost effective fabrication protocol for DSSCs and to introduce use of flexible, non platinized conducting carbon cloth as counter electrode for flexible DSSCs.

### BRIEF DESCRIPTION OF THE DRAWINGS

Scheme1 represents synthesis of carbon cloth from cellulose fabric

FIG. 1 shows a) XRD of carbon cloth b) Raman spectra for carbon cloth.

FIG. 2 depicts a-d) FESEM (Field Emission Scanning Electron Microscopy) images of carbon cloth.

FIG. 3 shows frequency dependent conductivity data for carbon cloth.

FIG. 4 shows Cyclic Voltammetry Curve for cloth-Pt, graphite-Pt and Pt—Pt cases in a) three electrode system from 0.7 to 2 V; b) two electrode system from 0-2.5V.

FIG. 5 depicts Tafel plot for cloth-Pt and graphite-Pt in three electrode system.

FIG. 6 shows a) H₂ measured at 1V and 2V applied potential for cloth, graphite and Pt as anode.

FIG. 7 shows a) and b) C1s and O1s spectra of cloth before electrolysis; c) and d) C1s and O1s spectra of cloth after electrolysis.

FIG. 8 shows FTIR-ATR spectra of fresh cloth and used cloth after electrolysis.

FIG. 9 a-d depicts High-resolution transmission electron microscopy (HRTEM) images of carbon quantum dots generated from carbon cloth.

FIG. 10 depicts Photoluminescence spectra of carbon quantum dots dispersed in water inset shows blue color fluorescence of carbon quantum dots under UV light.

FIG. 11 shows the cyclic voltametry measurements of conducting carbon cloth and platinum

FIG. 12 depicts Current vs Voltage (I-V) characteristics of carbon cloth as counter electrode in DSSC.

FIG. 13 depicts I-V data on flexible DSSC, using carbon cloth as counter electrode and Indium Tin Oxide (ITO) coated Polyethylene terephthalate (PET) as anode substrate.

FIG. 14 depicts (I) Regular protocol for DSSC fabrication, (II) Revised simplified protocol for DSSC fabrication with the use of carbon cloth as counter electrode.

### SUMMARY OF THE INVENTION

The present invention is about a functional conducting carbon cloth having permeability and turbostratic disorder, which can show high efficiency of hydrogen evolution at sub-threshold (<1.23V) voltages in alkaline water electrolysis. In the same process, above the threshold potential (>1.23V) carbon quantum dots are generated. The invention describes the process for preparing such a cloth electrode as well. Further it describes use of said carbon cloth as an efficient counter electrode for Dye Sensitized Solar Cell application. Moreover, the permeability of the cloth allows easier process of fabrication of the DSSCs.
Accordingly, present invention provides a conducting carbon cloth as anode having mesh size ranging from 5 to 50 micron and having turbostratic structure.
In an embodiment of the present invention, said cloth is useful for generation of hydrogen at sub-threshold potential, less than 1.23 V, preferably 0.2V; in alkaline water electrolysis.
In another embodiment of the present invention, said cloth is useful for generation of carbon quantum dots (CQDs) at super-threshold potential, more than 1.23V, preferably 2.0V in alkaline water electrolysis.
In yet another embodiment of the present invention, hydrogen evolution at 1V is 24 mLcm⁻².
In yet another embodiment of the present invention, the size of carbon quantum dots is in the range of 6-8 nm.
In yet another embodiment of the present invention, the alkaline electrolyte used is 1M NaOH.
In yet another embodiment of the present invention, the hydrogen generation is carried out without evolution of carbon dioxide.
In yet another embodiment of the present invention, conducting carbon cloth as counter electrode for DSSC exhibit 5 to 8% efficiency.
In yet another embodiment of the present invention, said cloth is characterized by XRD having characteristic peaks at 2θ value of 25 and 44; by Raman spectrum, where I_{D}/I_{G} ratio is about 1.2 and by FTIR, where peaks appear at 1640 cm⁻¹ and 3317 cm⁻¹.
In yet another embodiment, present invention provides a process for preparation of conducting carbon cloth as claimed in claim 1, comprising the steps of:
   i. subjecting the cellulose fabric to pyrolysis at temperature in the range of 800 to 1200° C. for period in the range of 4 to 6 hrs with a heating rate of 5 to 10° C. per min in a split tube furnace under continuous flow of argon gas to obtain a black colored conducting carbon cloth.

### DETAILED DESCRIPTION OF THE INVENTION

“Cloth” means any cellulose fabric and other kinds of fabric such as rayon and natural silk. The invention provides a simultaneous process for generation of hydrogen at sub-threshold potential and generation of carbon quantum dots (CQDs) at super-threshold potential in alkaline water electrolyte comprising of functional conducting carbon cloth as anode having turbostratic structure; wherein the evolution of hydrogen is formed at subthreshold potential (0.2V) i.e lower than the required practical potential of 1.23V, simultaneously generation of carbon quantum dots at super threshold potential >1.23V i.e. 2.0V.

Accordingly, during the electrolysis the hydrogen generation is formed at sub threshold potential i.e. (0.2 V); with simultaneous rapid exfoliation of nanoscale carbon quantum dots (CQDs) at superthreshold potential i.e. (2.0V), in alkaline water electrolysis cell comprising, employing conducting carbon cloth as anode having turbostratic structure.

The threshold potential or practically required potential 1.7 V is theoretically considered to be 1.23V.

Further the highly efficient carbon cloth is synthesized by one step, simple pyrolysis of readily available cellulose fabric at 1000° C.

The invention describes alkaline water electrolysis using a low cost functional carbon cloth as anode which shows an onset of hydrogen generation much below 1.23 V. The instant invention demonstrates the efficient use of functional carbon cloth anode with turbostratic disorder in the alkaline electrolysis process which not only reduces the cost because of sub-threshold hydrogen generation but also act as the source of carbon quantum dot formation. The sub-threshold hydrogen generation at 0.2V in two electrode system is due to the turbostratic disorder present in the carbon cloth which provides plenty of defects sites for the slow oxidation of carbon in 1M NaOH electrolyte. In two electrode system, the quantity of hydrogen evolved was measured to be 24 mlcm⁻² at 1V with a corresponding measured current of ˜40 mA. Interestingly at super-threshold potential along with the high quantity of hydrogen generation because of high potential the oxidized carbon comes out from the cloth surface as carbon quantum dots (6-8 nm) which show bright blue fluorescence under UV light.

The invention provides the synthesis of functional conducting carbon cloth by subjecting the cellulose fabric to pyrolysis at 1000° C. for 4 to 6 hrs with a heating rate of 10° C. per min in a split tube furnace under continuous flow of argon gas to obtain a black colored, conducting, turbostratic carbon cloth which is directly used as an anode for water electrolysis process.

Turbosatric disorder is the order which arises because of incomplete graphitization of the carbon materials. This is due to the lack of the ordering in the carbon layers because of the insufficient processing temperature. The cotton cloth is been pyrolyzed at 1000° C., and not at the temperature for graphitization, which is beyond >3000° C. Therefore the carbon cloth formed is only partially graphitized. The ordering of carbon layers as observed in case of graphite is absent in such a turbostratic carbon cloth. This type of disorder is called turbostratic disorder. Because of this disorder there are more active sites present in the carbon cloth for the surface reactions.

The carbon cloth obtained was characterized using various techniques include X-ray powder diffraction, Raman spectroscopy, high-resolution transmission electron microscopy, field-emission scanning electron microscopy. The surface of cloth was examined by X-ray photoelectron spectroscopy.

The invention provides low cost functional conducting carbon cloth for alkaline water electrolysis characterized by XRD having characteristic peaks at 2θ value of 25 and 44 corresponding to the (002) and (101) planes of graphitic carbon by Raman spectrum having D and C bands at 1300 cm−1 and 1590 cm−1 with an intensity ratio of ID/IG˜1.2 wherein, G-band represents the presence of graphitic nature and D band corresponds to the defects presents in the system.

The invention provides conducting carbon cloth with turbostratic structure characterized by XRD having characteristic peaks at 2θ value of 25 and 44; by Raman spectrum, where I_{D}/I_{G} ratio is about 1.2 and by FTIR, where peaks appear at 1640 cm⁻¹ and 3317 cm⁻¹.

The invention provides mechanism of the sub-threshold hydrogen generation and super-threshold carbon quantum dot formation, using said functional conducting carbon cloth as electrode.

The instant invention also uses the conducting carbon cloth as counter electrode for DSSC application. In view of the low carbonization temperature (1000° C.) which forbids full graphitization, the nature of carbon in this case is represented by topologically randomly assembled nanoscale graphene units (turbostratic carbon). This morphology has high density of edge states and oxygen containing surface groups rendering multitude of catalytic sites for the reduction of I₃—. The porous nature of this cloth makes it permeable to the liquid electrolyte and its absorption properties retain the electrolyte. This strategy excludes the complete step of drilling hard Transparent conducting oxide (TCO) which reduces the cost and time of fabrication of DSSCs. Platinum is also replaced with a cheaper conducting carbon cloth which can be synthesized in bulk amounts.

In the process, the conducting carbon cloth is fixed to TCO with the help of a sealing material (e.g. two part epoxy resin). The same sealant is applied to photoanode and electrolyte is poured onto the counter electrode. Both the electrodes are sandwiched together and dried for an hour at room temperature. An efficiency of 5.8% is achieved on Florine doped tin oxide (FTO) glass substrates using carbon cloth counter electrode.

The carbon cloth was used as counter electrode for flexible ITO-PET devices which showed an efficiency of 0.5%.

The low cost carbon cloth is achieved by manipulating its properties such as high conductivity, porosity and structural defects. Importantly, the porous structure with high amount of defects and high conductivity of the functional cloth allows high current densities comparable to precious platinum. The turbostratic disorder in the structure of the cloth facilitates oxidation during the electrolysis process which starts off at as low a voltage as ˜0.2 V. Although this process is also carbon-assisted water electrolysis, the extent of carbon oxidation is intrinsically controlled leading to oxygen evolution instead of CO₂ as reported by Farooque et al. and Seera et al. in Carbon-assisted water electrolysis: An energy-efficient process to produce pure H₂ at room temperature, Appl. Phys. Lett., 2007, 90, 044104 with addition of carbon slurry.

The instant inventors have surprisingly found that, there is formation of copious quantity of carbon quantum dots (CQDs) from the cloth anode in the electrolyte especially, when the operating voltage is beyond water decomposition i.e. when a >1.7 V potential is applied. Apart from the sub-threshold hydrogen evolution process, the turbostratic disorder in the structure of the cloth facilitates oxidation of the carbon surface during electrolysis, which reduces the overall activation energy with simultaneous production of carbon quantum dots when a >1.7 V potential is applied. The microstructure and electrochemical properties of this most interesting anode material is investigated and the underlying mechanism for sub-threshold hydrogen generation and super-threshold carbon quantum dot formation is presented herein below.

In another aspect, the carbon cloth is used as a counter electrode in a DSSC, which can result in an efficiency of 5 to 8%.

Moreover, the permeable property of the cloth eliminates a complete step of drilling hard TCO substrates for final dispensing of electrolyte into the device. Also it facilitates the sealing process, thus making the entire fabrication process of DSSC's easier.

### EXAMPLES

Following examples are given by way of illustration and therefore should not be construed to limit the scope of the invention.

### Example 1

### Functional Conducting Cloth Synthesis

The cellulose fabric was placed in an alumina plate and was subjected to pyrolysis at 1000° C. for 4 Hr. The heating rate was 10° C. per min in a split tube furnace under continuous flow of argon gas. After the reaction was over a black colored conducting carbon cloth was obtained as in Scheme 1. It was characterized by several techniques and was directly used as an anode for water electrolysis process.

### Example 2

### Variations in the Synthesis Parameters

Mostly cellulose fabric has been used for this work but many kinds of fabric such as rayon, natural silk etc may be used. Apart from the types of fabric, the heating rate and the temperature also affect the structure and order of defects in the carbon cloth. The variation, in the pyrolysis temperature has also been studied by heating the fabric at different temperature such as 600° C., 800° C. and such like with different rate of heating.

### Example 3

### Characterization of the Conducting Carbon Cloth

The synthesized cloth material was characterized by X-ray powder diffraction using Philips X'Pert PRO diffractometer with nickel-filtered Cu Kα radiation, Raman spectroscopy using Lab RAM HR800 from JY Horiba, high-resolution transmission electron microscopy using IFEI, Tecnai F30, with 300 KV FEG and field-emission scanning electron microscopy (FESEM; Hitachi S-4200). The surface of cloth was examined by X-ray photoelectron spectroscopy on a VG scientific ESCA-3000 spectrometer using non monochromatized Mg Kα radiation (1253.6 eV) at a pressure of about 1×10⁻⁹ Torr. All the electrochemistry measurements were done with Autolab PGSTAT30 (Eco-Chemie).

### Example 4

### Electrochemical Measurements for Water Electrolysis Process

All the electrochemical experiments were performed in a closed glass cell made up of three separated chambers using different types of anodes (carbon cloth, graphite, platinum), cathode (platinum) and for reference electrode (Saturated calomel electrode). All the three chambers were connected with glass frit for ion transport. All the measurements were performed with both the three and two electrode systems. The electrolyte used for the measurements were 1M NaOH. For the electrolysis process 100 ml of electrolyte was poured in the glass assembly and the anode/cathode were placed into it through a crocodile-pin contact. For all the measurements in three electrode system saturated calomel reference electrode was used. External voltage of 0-2V was supplied through the potentiostat and the current was measured from by cyclic voltammetry. Autolab PGSTAT 30-Eco-Chemie was used to sweep the voltage at a scanning rate of 10 mV s⁻¹.

### Example 5

### Gas Analysis

All the gases evolved at the anode and the cathode, were analyzed by Gas Chromatography (GC). A closed glass reaction cell with three electrode assembly, having provision for withdrawal of the gaseous samples at desired intervals, was employed in these experiments. Prior to each experiment, the reaction cell was purged with nitrogen for a few minutes. The evolved hydrogen was sampled with a 500 μl syringe (Hamilton) and analyzed periodically by using the gas chromatograph (Agilent model-1020), equipped with a 9 ft Mol-Sieve 5A column having argon as the carrier gas and a thermal conductivity detector maintained at 400 K. All the CO₂ detection experiments were performed with the porapack Q column.

### Example 6

### Purification of Carbon Quantum Dots

Carbon quantum dots were synthesized by using two electrode system with the cloth as anode and Pt as cathode with 100 ml of 1M NaOH in a 250 ml glass beaker. A constant potential of 2V was applied for 1 Hr between the electrodes. After 1 Hr a brown color solution was collected and diluted to 500 ml. The pH of the solution was neutralized to 7 by adding dilute HCl followed by the addition of ethanol drop by drop. To the above solution Mg₂SO₄ salt was added and stirred for 10 mins. This solution was then filtered and purified by using a dialysis membrane (3.5 kD). The purified quantum dot suspension was used for all the characterizations. The highly oxygen functionalized quantum dots can be reduced in the solution get graphene quantum dots.

### Example 7

### Characterization of Cloth as Counter Electrode

Cyclic voltametry (CV) was performed on carbon cloth counter electrode and compared with Pt electrode to study the electrochemical catalytic activity of these electrodes. CV was measured using a conventional three electrode system which consisted of Pt as counter electrode, Ag/AgCl as reference electrode and self made carbon cloth or Pt as working electrode. Lithium perchlorate was used as supporting electrolyte and acetonitrile as solvent.

### Example 8

### Characterization of Cloth Based Dye Sensitized Solar Cells (DSSC)

I-V data was measured under 1 Sun using AM 1.5 Solar simulator. The measurement was performed with the conducting carbon cloth counter electrode or Pt counter electrode and Ruthenium N719 dye loaded TiO₂ as working electrode sandwiched together with I⁻/I₃⁻ as redox electrolyte in between.

### Example 9

### A: Characterizations Results of Carbon Cloth

FIG. 1a shows the XRD spectra for the pyrolyzed cloth which shows two prominent peaks at 2θ value of 26.4 and 44 which correspond to the (002) and (101) planes of graphitic carbon (2θ=23-26°). The Raman spectrum of the cloth shown in FIG. 1b also shows the D and G bands at 1300 cm⁻¹ and 1590 cm⁻¹, respectively. The G-band represents the presence of graphitic nature and D band corresponds to the defects presents in the system. From this figure it can be clearly observed that the intensity of D band is higher than the G band with ID/IG ratio ˜1.2 which represents high amount of defects present in the cloth surface which is due to the imperfections in the turbostratic structure of the carbon cloth.

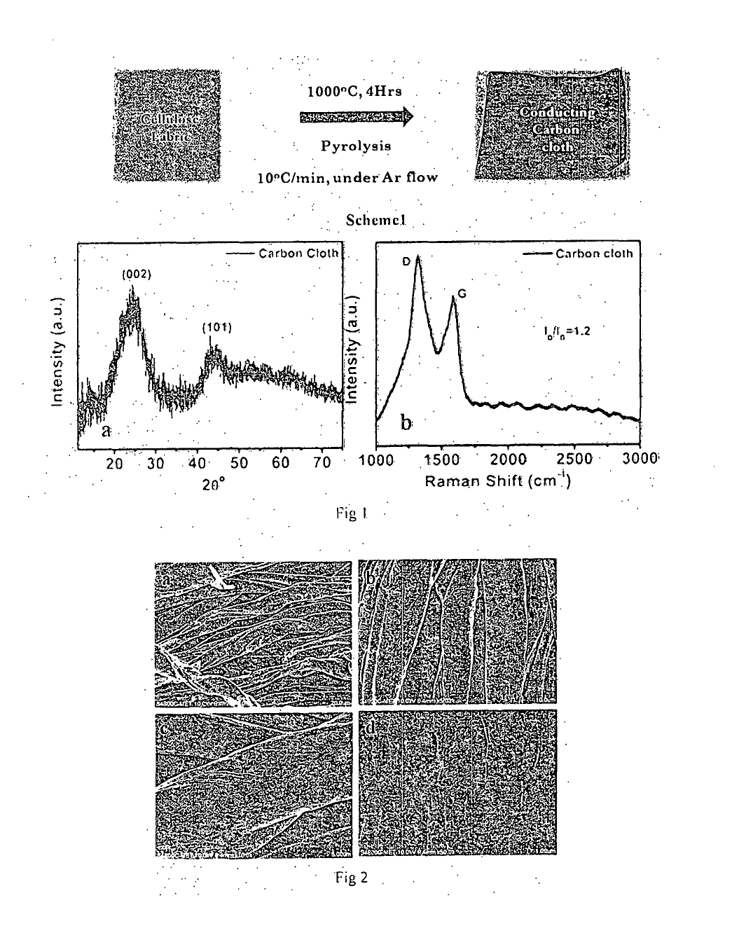

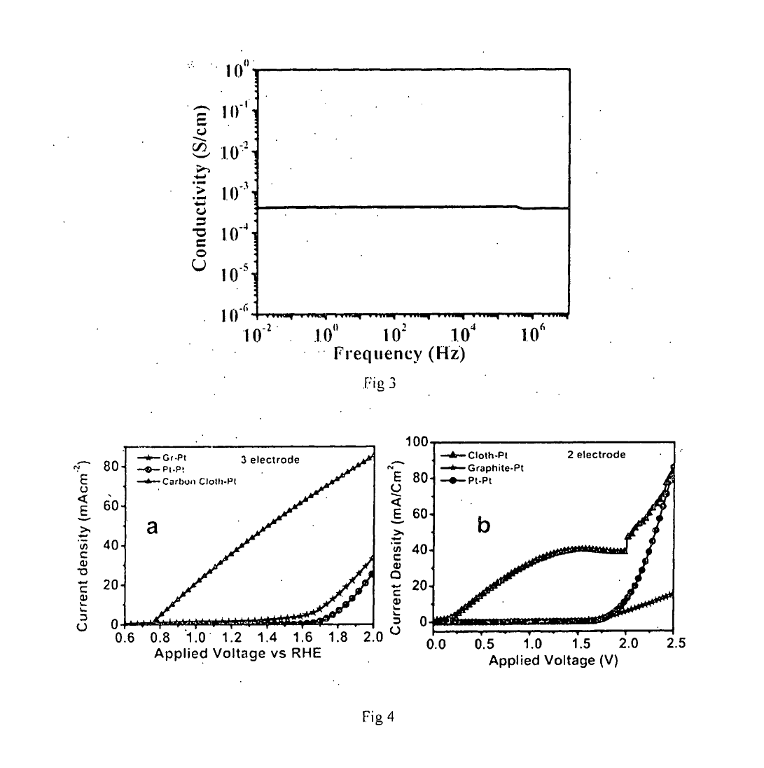

The microstructure of the synthesized carbon cloth was studied with FE-SEM as shown in FIG. 2a-d. Expectedly, these images show fibre-like structures present in the carbon cloth with rough surfaces. FIG. 3 represents the frequency dependant conductivity data which shows the cloth is highly conducting in nature.

### B: Sub-Threshold Hydrogen Generation

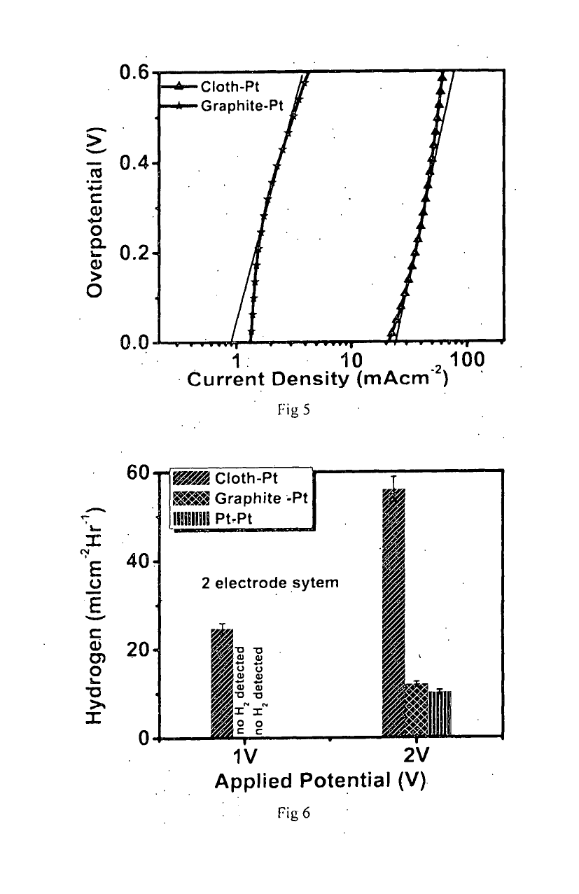

FIG. 4a shows the I-V scan of the water electrolysis process using functional cloth as anode and Pt foil as cathode in 1M NaOH electrolyte under three electrode system. For comparison I-V scans of graphite-Pt and Pt—Pt combinations of anode-cathode are also presented. As seen in this plot; the functional cloth shows dramatically high current density as compared to both graphite and Pt anodes. In order to truly monitor the onset potential of the oxidization of anode the inventors further recorded the I-V data under two electrodes set up, which is shown in part b of FIG. 4.

From this plot it can be clearly seen that the plots for graphite and Pt anode start to take off above 1.5 V which is consistent with the reported operating potential for water splitting. However in case of functional cloth, the kick off is around 0.2 V which plateaus at around 1.5 and again takes off. We demonstrate that this sub-threshold hydrogen generation starts off due to oxidation (etherification) of the carbon on the surface of the turbostratic functional cloth. A current density as high as 32 mA/cm² was observed in this region which is almost 3 orders of magnitude higher compared to graphite and Pt as anode. Beyond 1.5 V there is change in the rate of hydrogen generation as seen in the change of slope in the I-V plot for cloth, which is associated to the take-over of regular water electrolysis process similar to graphite and Pt anodes. This can also be more clearly understood from the tafel plot shown in FIG. 5 which represents the exchange current density calculated by drawing a tangent to the x-axis. From this graph it was observed that the exchange current density is the case of carbon cloth is higher (13 mAcm⁻²) than the graphite and Pt as anodes.

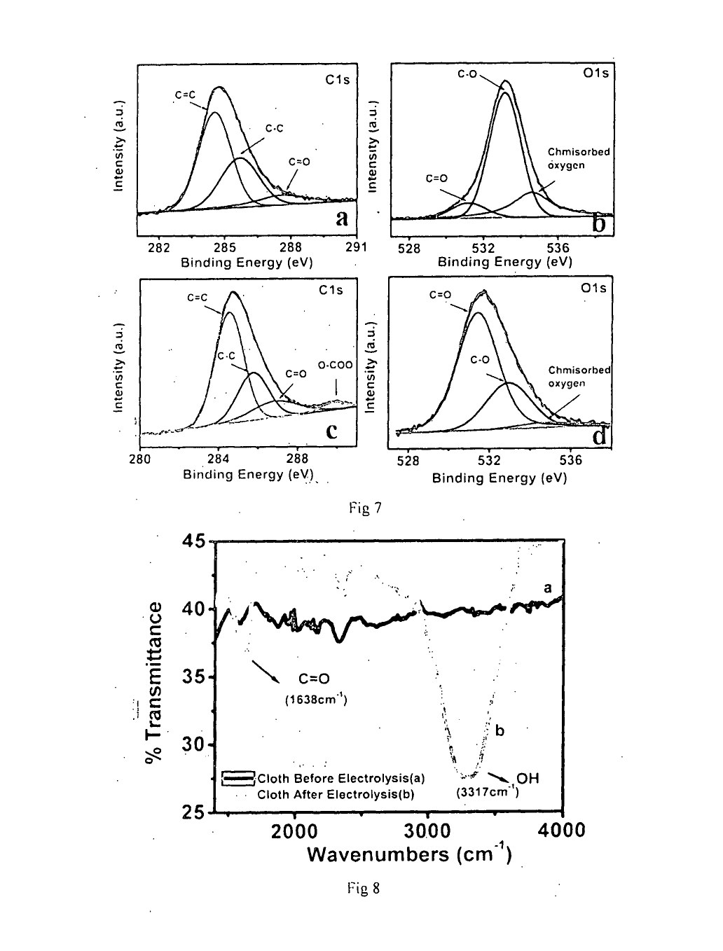

The evolved hydrogen was measured using Gas Chromatography as presented in FIG. 6. In this plot the total amount of hydrogen evolved over one hour is presented when a constant voltage of 1V (sub-threshold) and 2V (super-threshold) was applied. The most important thing to note here is that at 1 V only cloth showed hydrogen evolution (24 ml/cm²). Graphite and platinum did not show even a trace of hydrogen. At 2V there is an obvious increase in the yield for the case of cloth from 24 to 56 ml/cm², which is much higher (>5 times) than the amount of hydrogen evolved with graphite and platinum as anodes. The difference in hydrogen yield here is consistent with the differences in current densities measured via I-V scan. At all times the gas evolved at the anode was confirmed to be oxygen.

It is proposed that the primary reason for such a high rate of hydrogen evolution in the case of cloth as anode is due to the surface defects present in the carbon cloth. As this cloth has been synthesized at 1000° C., there is partial graphitization in the structure. However due to surface defects, there is lack of order which gives rise to turbostratic (disordered) structure. Such a turbostratic cloth has more surfaces available for the electrolysis process. At the same time it can undergo oxidation more easily. In 1M NaOH as electrolyte there is a high concentration of OH⁻ ions in a typical alkaline electrolysis process the OH⁻ ions get oxidized at the anode surface and form O₂ molecules. But in case of the turbostratic functional cloth, the OH⁻ ions can get adsorbed on the surface and can oxidize the carbon surface successively from C—OH to C═O to —COOH etc. under the applied potential. These oxidation reactions can start at very low potentials, they are exothermic in nature and they cause irreversible changes on the surface of the cloth. Thus the required energy for hydrogen generation below the threshold voltage of 1-23V is taken from the oxidation of carbon surface. Therefore as the cloth itself participates in the electrolysis process, the overall efficiency of hydrogen generation is higher as compared to pure electrolytic water splitting. This is carbon-assisted water electrolysis however the distinct difference with respect to the slurry work is that herein instead of CO₂. oxygen gas is getting evolved and the electrode is undergoing chemical change (oxidation). To confirm this proposed mechanism, the inventors have investigated the functional cloth which had undergone the electrolysis process by x-ray photoelectron spectroscopy (XPS). The data are shown in FIG. 7. The parts (a) and (c) in this figure show the C1s spectra of fresh cloth and electrochemically processed cloth, respectively. In the case of the fresh cloth the C1s spectrum can be fitted with three major peaks which correspond to C═C (binding energy 284.6 eV), C—C (binding energy 285.67 eV) and C═O (binding energy 287.8 eV).

This clarifies that the fresh cloth contains only a few percent oxygen containing groups on the surface. However the C1s spectrum of the electrochemically processed carbon cloth shows an additional peak at binding energy 289.7 eV along with the three peaks corresponding to C═C, C—C and C═O. This peak corresponds to O—COO which is ester and carboxylic group. This proves that during the electrolysis process the surface of the cloth undergoes oxidation (hydroxyl to carboxyl to ester groups getting attached to the carbon on the surface). In line with this FIG. 7 b and d depict the O1s spectra of the fresh cloth and the electrochemically processed cloth, respectively. In the case of fresh cloth the O1s spectrum consists of 3 peaks which belong to C—O (binding energy 533.1 eV), C═O (binding energy 531.26 eV) and chemisorbed oxygen (binding energy 534.6 eV). In case of the electrochemically processed cloth the intensity of C═O peak is enhanced (highest intensity peak) as compared to the fresh cloth case. This is also due to the anodic oxidation observed during the electrolysis process.

FIG. 8 shows the FTIR spectra for the cases of fresh cloth and electrochemically processed cloth from electrolysis in the attenuated total reflection (ATR) mode to further reveal the oxidation process during electrolysis. In the case of electronically processed cloth the peak appearing at ˜1640 cm⁻¹ is associated with carbonyl or quinine groups present on the surface which is almost absent in case of the fresh cloth. The appearance of this peak clearly indicates the electrochemical oxidation of carbon cloth surface during electrolysis. Also the emergence of the giant broad peak at ˜3317 cm⁻¹ due to the OH groups present on the carbon surface distinguishes the surface of the electrochemically processed cloth from the fresh one indicating that the processed cloth has undergone stronger oxidation.

In line with carbon assisted water electrolysis proposed by Farooque et al. and later studied in more details by Seera et al. the instant inventors have studied the electrochemical performance of the functional conducting cloth in an acidic medium. Since under acidic conditions the cloth surface is even more prone to oxidation, the inventors observed that with 3.7M HNO₃ as electrolyte the cloth underwent complete oxidation and released CO₂ instead of O₂ at voltages lower than 1.23V. This is consistent with the observation for coal slurry in acidic water. But since the cloth itself is conducting, it could act as both the electrode and at the same time a sacrificial component getting oxidized itself into CO₂.

### C: Super-Threshold Carbon Quantum Dot Formation

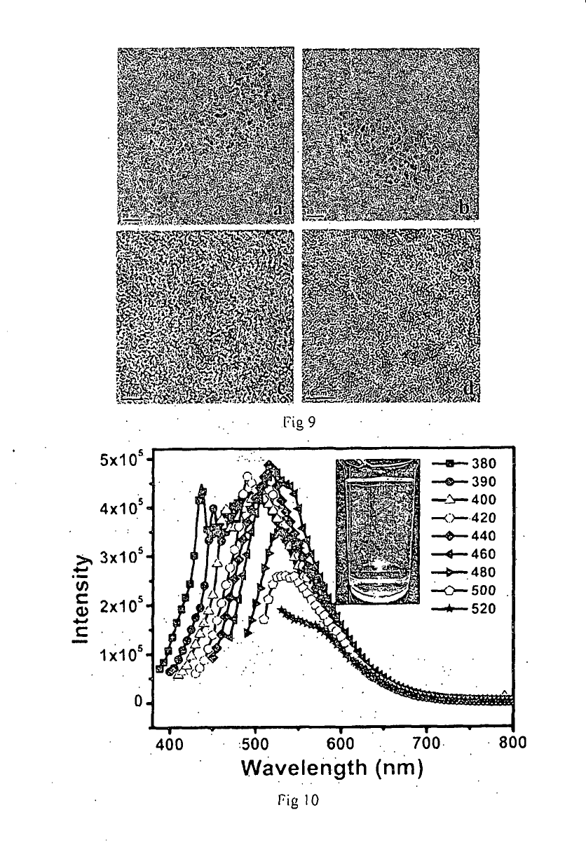

When a potential above 1.5V (1.23+overpotential) is applied during the electrolysis with the functional conducting carbon cloth as an anode and Pt as a cathode, a very interesting observation was made. It was observed that the electrolyte solution slowly turned brown in colour. This was not observed when graphite or platinum was used as anode. When this solution was purified and characterized with HR-TEM and photoluminescence spectra, it was observed that it contained carbon quantum dots. The HR-TEM images show well dispersed 5-7 nm particles as shown in FIG. 9a-d.

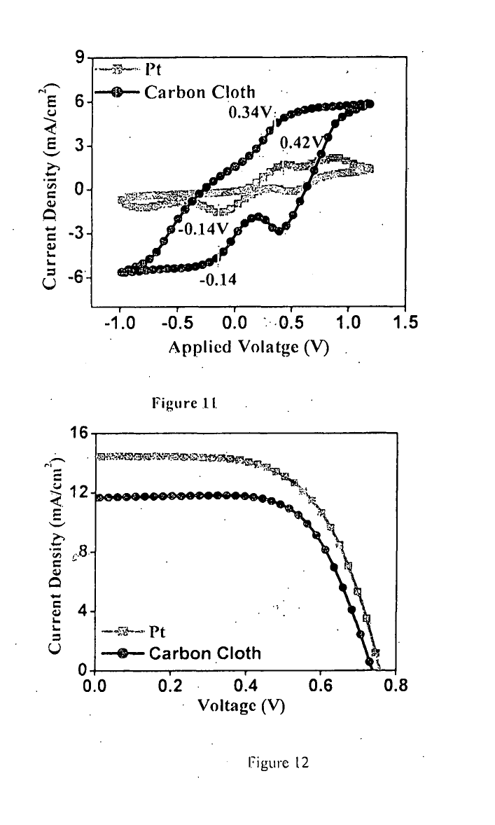

FIG. 10 represents the photoluminescence spectra of carbon quantum dots dispersed in water at different excitation wavelengths. The PL spectra show that the fluorescence emission of carbon quantum dots are excitation dependant which is commonly observed in case of carbon and graphene quantum dots. The fluorescence peak shifted from 490 to 527 when the excitation wavelength changed from 380 to 480 nm. Also the peak intensity is observed to decrease with increase in the excitation wavelength. The inset of this figure shows the bright blue coloured emission of carbon quantum dots (CQDs) under UV light.

Upon careful observation of the I-V data and onset of quantum dot formation, it is evident that the sub-threshold hydrogen generation and super-threshold quantum dots formation processes are actually interlinked. The quantum dot formation process only starts when the hydrogen generation through water splitting takes over above 1.5 V. Hence again this quantum dot formation mechanism can be explained on the basis of anodic oxidation of the carbon cloth. Often in electrochemical processes of carbon based electrodes it has been observed that the electrode itself undergoes reduction or oxidization and there are some reports of formation of graphene or carbon quantum dots using this approach. In the instant case, the oxidation of turbostratic cloth surface in alkaline electrolyte, at potentials up to 1.5V, the OH⁻ ion get bonded to the carbon surface and form C—OH along with the release of one electron. Subsequent oxidation continues forming —HC═O, —C═O, —COOH and also —O—COO— etc. with each step releasing corresponding number of electrons. However above a particular cut-off voltage, the carbon itself breaks out of the surface forming quantum dot. Since it starts off above ˜1.5V, probably the release of oxygen gas molecules at anode can also help in the dissociation of carbon from the surface. However, this dissociation was possible into small CQDs only due to the highly disordered turbostratic structure of the functional carbon cloth. Although there have been several reports of electrochemical synthesis of graphene and carbon quantum dots (L. Zheng et al. J. Am. Chem. Soc. 2009, 131, 4564), however, is the use of the most dilute condition in terms of electrolyte concentration, number of cyclic voltammetry cycles and applied voltage, where carbon quantum dot synthesis occurs.

### D Carbon Cloth as Counter Electrode for DSSC

Cyclic voltametry measurements were also performed for this carbon cloth to check with its catalytic properties for redox reactions of electrolyte (FIG. 11). This data was compared with that of the usual Pt counter electrode. From the data it is clear that the carbon cloth shows catalytic activity towards redox reactions of electrolyte showing small peaks at 0.43V for oxidation of I⁻ and at −0.21V for reduction of I₃⁻. This activity is due to oxygen containing functional groups present on the surface e of carbon cloth.

FIG. 12 shows the IV data recorded for the carbon cloth as counter electrode and regular Pt counter electrode. Carbon cloth counter electrode showed power conversion efficiency of 5.8% compared to 7% for Pt counter electrode It is seen that the photo current density of carbon electrode is less than that of Pt counter electrode which may be attributed to its relatively low catalytic property for redox reactions of electrolyte compared to Pt. Low catalytic property of carbon cloth may be the reason behind slight decrease in V_{oc} of carbon cloth counter electrode which can be attributed to recombination of charges at the electrode/electrolyte interface.

| Name | V_{oc} (V) | J_{sc} (mA/cm²) | FF (%) | η % |
|---|---|---|---|---|
| Pt | 0.77 | 14.4 | 61 | 7.0 |
| Carbon Cloth | 0.73 | 11.6 | 65 | 5.8 |

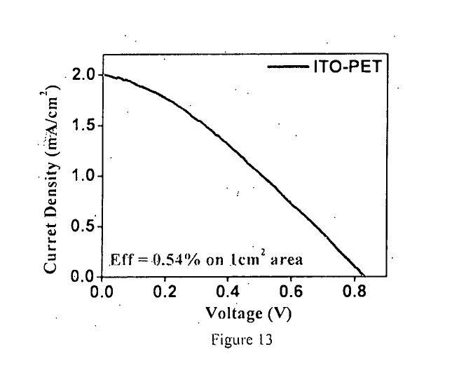

IV data was also recorded for flexible DSSC on ITO-PET (Indium Tin Oxide coated Polyethylene terephthalate) substrate with conducting carbon cloth as a counter electrode (FIG. 13). It showed a nominal efficiency of 0.5% which can be pushed to 1.5% with further optimizations and modifications.

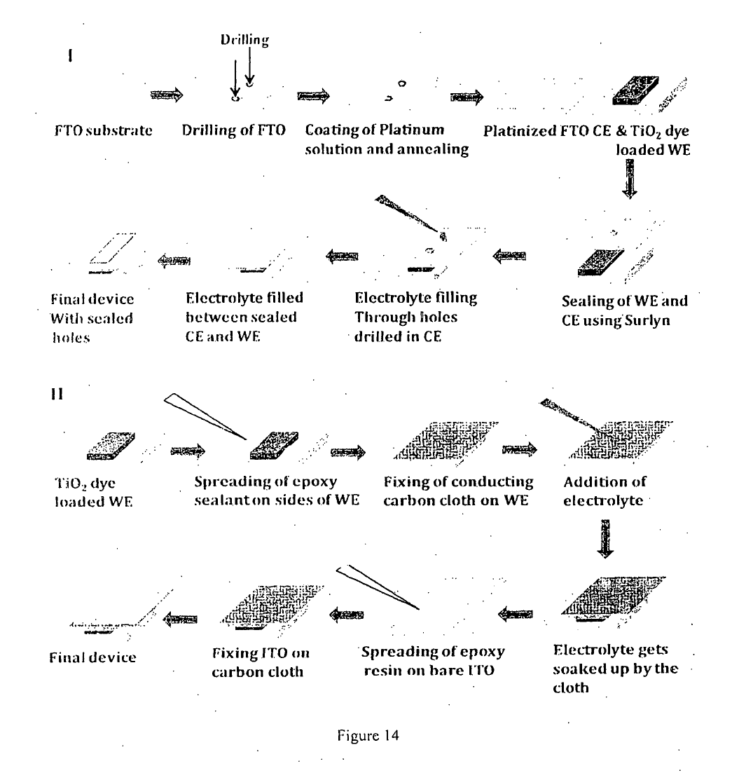

The use of carbon cloth as counter electrode makes the DSSC fabrication process much simpler. The time consuming process of drilling holes in FTO is completely removed and also the tedious process of sealing of cell is rendered facile and trouble-free. FIG. 14 (I) shows the regular DSSC fabrication protocol while FIG. 14 (II) shows the modified fabrication protocol which is clearly simpler.

### ADVANTAGES OF THE INVENTION

There are several advantages of the inventions over the state of art which are listed below.
The carbon cloth was synthesized in large scale from the readily available cellulose fabric by simple pyrolysis at 1000° C.
Apart from cellulose fabric many other fabric such as silk and rayon can also be used for the synthesis of carbon cloth which are readily available sources.
Use of highly conducting carbon cloth electrode as anode in alkaline electrolysis process replaces the costly Pt electrode.
Because of turbostatic disorder present in the carbon cloth the threshold for the oxidation reactions decreases substantially and hence sub threshold (<1.23V) hydrogen generation takes place at much lower potential ˜0.2V.
The lowering of this threshold potential is due to the slow oxidation of carbon cloth electrode surface which itself provides energy to the whole process and reduces the energy requirement from the circuit.
The gasses at the cathode and anode are hydrogen and oxygen and here is no toxic carbon monoxide and carbon dioxide evolution was observed during the electrolysis.
At low potential such as 1V the evolved hydrogen was measured to be 24 mlcm⁻²Hr⁻¹ which is much higher in carbon cloth anode than the commercially used anodes as these anodes only produces hydrogen after the threshold potential (1.23V).
At super-threshold potential (>1.23V) a brown color solution comes out from the cloth surface to the electrolytes which was found to be carbon quantum dots with bright blue fluorescence.
These quantum dots synthesized at low potential such as 2V are biocompatible and are highly useful for bio-imaging, device applications etc.
The use of conducting carbon cloth eliminates a step of drilling TCO substrates which facilitates fabrication process of DSSC.
Use of this conducting carbon cloth as counter electrode gave an efficiency of 5.8% on FTO substrates.
The carbon cloth counter electrode made the fabrication process simpler and cost effective.
Thus the highly conducting carbon cloth according to the invention is a promising anode material for the energy efficient hydrogen generation which produces hydrogen at very low potential such as 0.2V and by operating the cloth at super-threshold potential such as 2V, large quantity carbon quantum dots can be synthesized at such as low potential. Along with that this conducting carbon cloth acts as an efficient counter electrode for Dye Sensitized Solar Cells with gives an efficiency of 5.8%.

1. A conducting carbon cloth as anode having mesh size ranging from 5 to 50 micron and having turbostratic structure.

2. The conducting carbon cloth as claimed in claim 1, wherein said cloth is useful for generation of hydrogen at sub-threshold potential, less than 1.23 V, preferably 0.2V; in alkaline water electrolysis.

3. The conducting carbon cloth as claimed in claim 1, wherein said cloth is useful for generation of carbon quantum dots (CQDs) at super-threshold potential, more than 1.23V, preferably 2.0V in alkaline water electrolysis.

4. The conducting carbon cloth as claimed in claim 1, wherein hydrogen evolution at 1V is 24 mLcm⁻².

5. The conducting carbon cloth as claimed in claim 1 and 3, wherein the size of carbon quantum dots is in the range of 6-8 nm.

6. The conducting carbon cloth as claimed in claim 1-3, wherein the alkaline electrolyte used is 1M NaOH.

7. The conducting carbon cloth as claimed in claim 1, wherein the hydrogen generation is carried out without evolution of carbon dioxide.

8. The conducting carbon cloth as claimed in claim 1, wherein conducting carbon cloth as counter electrode for DSSC exhibit 5 to 8% efficiency.

9. The conducting carbon cloth as claimed in claim 1, wherein said cloth is characterized by XRD having characteristic peaks at 2θ value of 25 and 44; by Raman spectrum, where I_{D}/I_{G} ratio is about 1.2 and by FTIR, where peaks appear at 1640 cm⁻¹ and 3317 cm⁻¹.

10. A process for preparation of conducting carbon cloth as claimed in claim 1, comprising the steps of:
i. subjecting the cellulose fabric to pyrolysis at temperature in the range of 800 to 1200° C. for period in the range of 4 to 6 hrs with a heating rate of 5 to 10° C. per min in a split tube furnace under continuous flow of argon gas to obtain a black colored conducting carbon cloth.
